(19) United States
(12) Patent Application Publication
(10) Pub. No.: US 2026/0262058 A1
(43) Pub. Date: Sep. 3, 2026

(54) SIDELINK COMMUNICATION METHOD AND APPARATUS

(71) Applicant: Beijing Xiaomi Mobile Software Co., Ltd., Beijing (CN)

(72) Inventor: Xing YANG, Beijing (CN)

(21) Appl. No.: 18/846,602

(22) PCT Filed: Mar. 17, 2022
(86) PCT No.: PCT/CN2022/081552

§ 371 Date: Sep. 12, 2024

(51) Int. Cl. H04W 72/25; H04B 17/318; H04W 72/30

(52) U.S. Cl. CPC H04W 72/25; H04B 17/328; H04W 72/30

(57) ABSTRACT

A sidelink communication method and apparatus are provided where the sidelink communication method includes: receiving sidelink transmission resource information from a network device, where the sidelink transmission resource information at least includes sidelink transmission resource information on a shared frequency; and selecting a sidelink transmission resource for transmitting a sidelink message according to the sidelink transmission resource information.

### CROSS-REFERENCE TO RELATED APPLICATIONS

The present application is a U.S. National Stage of International Application No. PCT/CN2022/081552, filed on Mar. 17, 2022, the contents of all of which are incorporated herein by reference in their entireties for all purposes.

### BACKGROUND OF THE INVENTION

At present, in order to support a sidelink communication between user equipment (UE) and user equipment, a sidelink communication mode is introduced, and an interface between the user equipment and the user equipment is PC-5.

### SUMMARY OF THE INVENTION

An example of a first aspect of the disclosure provides a sidelink communication method, performed by a terminal device, including: receiving sidelink transmission resource information from a network device, where the sidelink transmission resource information at least includes: sidelink transmission resource information on a shared frequency; and according to the sidelink transmission resource information, selecting a sidelink transmission resource for transmitting a sidelink message.

An example of a second aspect of the disclosure provides another sidelink communication method, performed by a network device, including: transmitting sidelink transmission resource information to a terminal device, where the sidelink transmission resource information at least includes: sidelink transmission resource information on a shared frequency.

An example of a third aspect of the disclosure provides a sidelink communication apparatus, including one or more processors and a memory, where
the one or more processors are collectively configured to:
receive sidelink transmission resource information from a network device, wherein the sidelink transmission resource information at least includes: sidelink transmission resource information on a shared frequency; and
select a sidelink transmission resource for transmitting a sidelink message according to the sidelink transmission resource information.

An example of a fourth aspect of the disclosure provides another sidelink communication apparatus, including a processor and a memory, a computer program is stored in the memory, and the computer program stored in the memory is executed by the processor so as to enable the apparatus to execute the method according to the example of the second aspect of the disclosure.

An example of a fifth aspect of the disclosure provides a non-transitory computer readable storage medium, configured to store an instruction. When the instruction is executed, the method according to the example of the first aspect of the disclosure is implemented.

An example of a sixth aspect of the disclosure provides another non-transitory computer readable storage medium, configured to store an instruction. When the instruction is executed, the method according to the example of the second aspect of the disclosure is implemented.

Additional aspects and benefits of the disclosure will be partly given in the following description, and will become apparent from the following description, or be learned through the practice of the disclosure.

### BRIEF DESCRIPTION OF DRAWINGS

In order to more clearly illustrate technical schemes in examples or a background of the disclosure, accompanying drawings that need to be used in the examples or the background of the disclosure will be described below.

FIG. 1 is a schematic structural diagram of a communication system provided by an example of the disclosure.

FIG. 2 is a schematic flowchart of a sidelink communication method provided by an example of the disclosure.

FIG. 3 is a schematic flowchart of another sidelink communication method provided by an example of the disclosure.

FIG. 4 is a schematic flowchart of another sidelink communication method provided by an example of the disclosure.

FIG. 5 is a schematic flowchart of another sidelink communication method provided by an example of the disclosure.

FIG. 6 is a schematic flowchart of another sidelink communication method provided by an example of the disclosure.

FIG. 7 is a schematic flowchart of another sidelink communication method provided by an example of the disclosure.

FIG. 8 is a schematic flowchart of another sidelink communication method provided by an example of the disclosure.

FIG. 9 is a schematic flowchart of another sidelink communication method provided by an example of the disclosure.

FIG. 10 is a schematic structural diagram of a sidelink communication apparatus provided by an example of the disclosure.

FIG. 11 is a schematic structural diagram of another sidelink communication apparatus provided by an example of the disclosure.

FIG. 12 is a schematic structural diagram of a network device provided by an example of the disclosure.

FIG. 13 is a block diagram of a terminal device provided by an example of the disclosure.

### DETAILED DESCRIPTION OF THE INVENTION

Examples will be illustrated in detail here, and their instances are shown in accompanying drawings. When the following description refers to the accompanying drawings, unless otherwise indicated, the same numbers in different accompanying drawings indicate the same or similar elements. Implementations described in the following examples do not represent all implementations consistent with the examples of the disclosure. Rather, they are merely instances of apparatuses and methods consistent with some aspects of the examples of the disclosure as detailed in the appended claims.

Terms used in the examples of the disclosure are merely for the purpose of describing specific examples, and are not intended to limit the examples of the disclosure. Singular forms “one” and “the” used in the examples of the disclosure and the appended claims are also intended to include plural forms unless the context clearly indicates other meanings. It is also to be understood that a term “and/or” as used here refers to and contains any or all possible combinations of one or more associated listed items.

It is to be understood that although terms first, second, third, etc. may be configured to describe various information in the examples of the disclosure, such information is not to be limited to these terms. These terms are merely configured to distinguish the same type of information from each other. For example, without departing from the scope of the examples of the disclosure, first information may also be referred to as second information, and similarly, the second information may also be referred to as the first information. Depending on the context, for example, words “in case of” and “if” as used here may be interpreted as “at the time” or “when” or “in response to determining”.

Please refer to FIG. 1. FIG. 1 is a schematic architecture diagram of a communication system provided by an example of the disclosure. The communication system may include but is not limited to a network device and a terminal device. The number and forms of devices shown in FIG. 1 are merely for example and do not constitute a limitation of the example of the disclosure, and two or more network devices and two or more terminal devices may be included in actual applications. The communication system shown in FIG. 1 is merely exemplified by including a network device 101 and a terminal device 102.

It needs to be noted that the technical scheme of the example of the disclosure may be performed by various communication systems, for example, a long term evolution (LTE) system, a 5th generation (5G) mobile communication system, a 5G new radio (NR) system, or other novel mobile communication systems in the future.

The network device 101 in the example of the disclosure is an entity on a network side and configured to transmit or receive a signal. For example, the network device 101 may be an evolved NodeB (eNB), a transmission reception point or transmit receive point (TRP), a next generation NodeB (gNB) in an NR system, a base station in other future mobile communication systems, an access node in a wireless fidelity (WiFi) system, etc. A specific technology and specific device form adopted for the network device is not limited by the example of the disclosure. The network device provided by the example of the disclosure may be composed of a central unit (CU) and a distributed unit (DU), where the CU may also be referred to as a control unit. Adopting a CU-DU structure may divide the network device, e.g., a protocol layer of the base station. A function of part of the protocol layer is placed in the CU for a central control. A function of part or all of the rest of the protocol layer is distributed in the DU, and the DU is centrally controlled by the CU.

The terminal device 102 in the example of the disclosure is an entity on a user side and configured to receive or transmit a signal, such as a mobile phone. The terminal device may also be called a terminal, user equipment (UE), a mobile station (MS), a mobile terminal (MT), etc. The terminal device may be a car with a communication function, a smart car, a mobile phone, a wearable device, a pad, a computer with a wireless transceiving function, a virtual reality (VR) terminal device, an augmented reality (AR) terminal device, a wireless terminal device in industrial control, a wireless terminal device in self-driving, a wireless terminal device in remote medical surgery, a wireless terminal device in a smart grid, a wireless terminal device in transportation safety, a wireless terminal device in a smart city, a wireless terminal device in a smart home, etc. A specific technology and specific device form adopted for the terminal device is not limited by the example of the disclosure.

In order to support a sidelink communication between user equipment (UE) and user equipment (UE), a sidelink communication mode is introduced, and an interface between the user equipment and the user equipment is PC-5. According to the correspondence between transmitting user equipment and receiving user equipment, three transmission modes are supported on a sidelink, i.e., unicast, multicast and broadcast.

A sidelink channel busy ratio (SL CBR) is a measurement result obtained by the UE in a time window according to a signal reception strength on a sidelink channel, and is configured to adjust transmission parameters of the UE, such as transmission power and priority settings. If a CBR (channel busy ratio) is high, the transmission power is reduced by the UE, and the transmission of low-priority data is reduced.

There are two modes to allocate transmission resources for the sidelink communication, one is a mode of dynamic network scheduling, and the other is a mode of self-selection of the UE in a resource pool of a broadcast of the network device. In the mode of dynamic network scheduling, the transmission resources on the sidelink are dynamically allocated by the network device to the UE according to a cache data report of the UE. The self-selection is a random selection of the transmission resources by the UE itself in a webcast or pre-configured resource pool. A resource pool of the mode of dynamic network scheduling and a resource pool of the mode of self-selection are separated, and the dynamic scheduling is that the resources are uniformly allocated by the network device, so the collision of different UE may be avoided through a reasonable algorithm.

The sidelink UE that is in an idle state and an inactive state needs to read the broadcast of the network device. If there is a sidelink transmission resource pool in the broadcast, sidelink transmission is performed by adopting the self-selection mode. Otherwise, the sidelink UE needs to enter into a connected state so as to transmit a request to the network device.

In order to better allocate the resources, a length and a width may be configured by the network device for the UE, and an identifier of an area where the UE is located may be calculated by the UE according to a latitude and longitude of a location where the UE is located. Different sidelink transmission resource pools may be selected by the UE according to the area where the UE is located, or whether to transmit feedback may also be selected according to the area where the UE is located.

There are two types of sidelink transmission, one is a sidelink communication, and the other is a sidelink discovery. The sidelink discovery may share a transmission resource pool with the sidelink communication, or may use an independent transmission resource pool. The resource pool is bound to an identifier that is configured to indicate whether the resource pool is dedicated to the sidelink discovery.

Sidelink transmission is usually performed by the user equipment (UE) on a sidelink transmission resource of an unshared frequency, and is not performed on a sidelink transmission resource of a shared frequency, such that the sidelink transmission resource on the shared frequency is not utilized, and a resource utilization rate is low.

Aiming at the above problems, the disclosure proposes a sidelink communication method and apparatus.

The disclosure relates to the technical field of communication, in particular to a sidelink communication method and apparatus.

In the technical scheme, the sidelink transmission resource information of the network device is received by the terminal device, where the sidelink transmission resource information at least includes: the sidelink transmission resource information on the shared frequency. According to the sidelink transmission resource information, the sidelink transmission resource is selected for transmitting the sidelink message, such that the sidelink transmission resource on the shared frequency can be utilized, and a resource utilization rate is improved.

It may be understood that the communication system described in the example of the disclosure is to more clearly illustrate the technical scheme of the example of the disclosure, and does not constitute a limitation on the technical scheme provided by the example of the disclosure. It may be known to those ordinarily skilled in the art that with the evolution of a system architecture and the emergence of new service scenarios, the technical scheme provided by the example of the disclosure is also suitable for similar technical problems.

The sidelink communication method and apparatus provided by the disclosure are introduced in detail below in conjunction with the accompanying drawings.

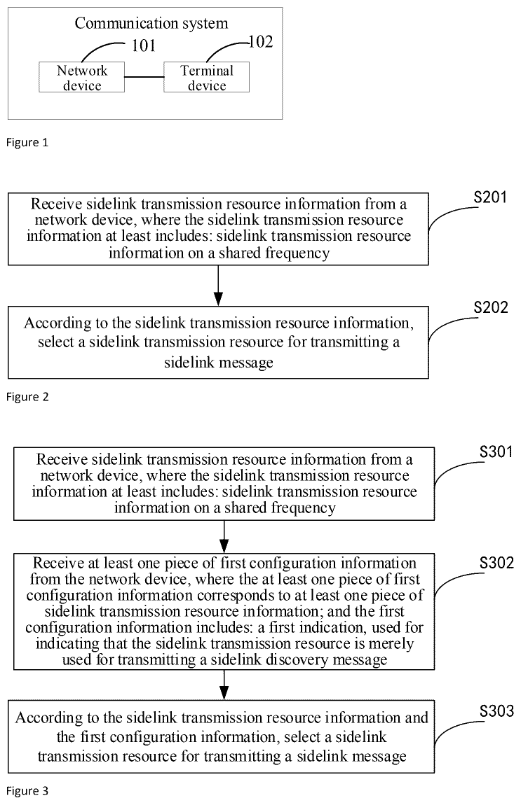

Please refer to FIG. 2 which is a schematic flowchart of a sidelink communication method provided by an example of the disclosure. The sidelink communication method may be performed by the terminal device in the communication system shown in FIG. 1.

As shown in FIG. 2, the sidelink communication method may include the following steps.
Step 201, sidelink transmission resource information is received from a network device, where the sidelink transmission resource information at least includes: sidelink transmission resource information on a shared frequency.

At least one piece of sidelink transmission resource information is provided. The at least one piece of sidelink transmission resource information may include: sidelink transmission resource information on the shared frequency and sidelink transmission resource information on an unshared frequency.

As an example, in response to that the terminal device is in an inactive state or an idle state, a system broadcast message is received from the network device, where the sidelink transmission resource information is carried in the system broadcast message. One system broadcast message may be provided. A plurality of pieces of sidelink transmission resource information transmitted by the network device through the one system broadcast message are received by the terminal device. A plurality of system broadcast messages may be provided. A plurality of pieces of sidelink transmission resource information transmitted by the network device through the plurality of system broadcast messages are received by the terminal device.

As another example, in response to that terminal device is in a connected state, a Radio Resource Control (RRC) message is received from the network device, where the sidelink transmission resource information is carried in the RRC message. One RRC message may be provided. A plurality of pieces of sidelink transmission resource information transmitted by the network device through the one RRC message are received by the terminal device. A plurality of RRC messages may be provided. A plurality of pieces of sidelink transmission resource information transmitted by the network device through the plurality of RRC messages are received by the terminal device.

In the example of the disclosure, when the terminal device is in a connected state, before receiving the sidelink transmission resource information on the shared frequency from the network device, the terminal device needs to report a capability indication to the network device. The capability indication is configured to indicate whether the terminal device supports transmission of the sidelink message by adopting a sidelink transmission resource on the shared frequency. The sidelink transmission resource information on the shared frequency is transmitted to the terminal device on a condition that the network device determines that the terminal device supports the transmission of the sidelink message by adopting the sidelink transmission resource on the shared frequency.

In an example, the capability indication may be configured to indicate that the user equipment supports that sidelink listen before talk (LBT) is performed on the sidelink transmission resource on the shared frequency. In another example, the capability indication may be configured to indicate that the user equipment supports that a failure detection of sidelink LBT is performed on the sidelink transmission resource on the shared frequency.

Reporting the capability indication to the network device includes reporting the capability indication to the network device on at least one frequency band, so that the sidelink transmission resource information on the shared frequency is transmitted by the terminal device with higher accuracy.

In the example of the disclosure, the terminal device is in an idle state or an inactive state, the capability indication does not need to be reported to the network device, the system broadcast message of the network device may be read, and the sidelink message is transmitted according to the sidelink transmission resource information carried in the system broadcast message.
Step 202, according to the sidelink transmission resource information, a sidelink transmission resource is selected for transmitting a sidelink message.

In the example of the disclosure, the sidelink transmission resource information is configured to indicate a sidelink transmission resource pool for transmission of the sidelink message. The sidelink transmission resource information includes: at least one time-frequency resource location, and the at least one time-frequency resource location is configured to indicate the sidelink transmission resource in the sidelink transmission resource pool.

One piece of sidelink transmission resource information may be configured to indicate one sidelink transmission resource pool for the transmission of the sidelink message. At least one piece of sidelink transmission resource information is provided. At least one sidelink transmission resource pool is provided. One sidelink transmission resource pool includes at least one time-frequency resource location. The at least one time-frequency resource location is configured to indicate at least one sidelink transmission resource in the sidelink transmission resource pool.

In summary, the sidelink transmission resource information from the network device is received, where the sidelink transmission resource information at least includes: sidelink transmission resource information on a shared frequency. According to the sidelink transmission resource information, a sidelink transmission resource is selected for transmitting a sidelink message, such that the sidelink transmission resource on the shared frequency can be utilized, and a resource utilization rate is improved.

An example of the disclosure provides another sidelink communication method. FIG. 3 is a schematic flowchart of another sidelink communication method provided by an example of the disclosure. The sidelink communication method may be performed by a terminal device. The sidelink communication method may be performed separately, or together in conjunction with any example in the disclosure or a possible implementation in the example, or in conjunction with any technical scheme in the related art.

As shown in FIG. 3, the sidelink communication method may include the following steps.
Step 301, sidelink transmission resource information is received from a network device, where the sidelink transmission resource information at least includes: sidelink transmission resource information on a shared frequency.

At least one piece of sidelink transmission resource information is provided. The at least one piece of sidelink transmission resource information may include: sidelink transmission resource information on the shared frequency and sidelink transmission resource information on an unshared frequency.

In the example of the disclosure, a plurality of pieces of sidelink transmission resource information are provided. One piece of sidelink transmission resource information includes a plurality of time-frequency resource locations. That is, a plurality of sidelink transmission resource pools are provided and include sidelink transmission resource pools on the shared frequency and sidelink transmission resource pools on the unshared frequency, and one sidelink transmission resource pool includes a plurality of sidelink transmission resources for transmitting sidelink messages.
Step 302, receive at least one piece of first configuration information from the network device, where the at least one piece of first configuration information corresponds to the at least one piece of sidelink transmission resource information. The first configuration information includes: a first indication, configured to indicate whether the sidelink transmission resource is configured to transmit a sidelink discovery message or a sidelink communication message.

In the example of the disclosure, the first configuration information corresponds to the sidelink transmission resource information. In an example, the at least one piece of first configuration information may be in one-to-one correspondence with the at least one piece of sidelink transmission resource information. In another example, one piece of first configuration information may correspond to one piece of sidelink transmission resource information, and may also correspond to a plurality of pieces of sidelink transmission resource information.

In the example of the disclosure, a plurality of pieces of sidelink transmission resource information are provided. A plurality of pieces of corresponding first configuration information are provided. In an example, in at least one piece of first configuration information, part of the first configuration information may include a first indication, and part of the first configuration information may not include the first indication. In another example, in at least one piece of first configuration information, all of the first configuration information may not include the first indication.
Step 303, according to the sidelink transmission resource information and the first configuration information, a sidelink transmission resource is selected for transmitting a sidelink message.

As an example, depending on different types of sidelink messages (whether they are sidelink discovery messages or sidelink communication messages), the sidelink transmission resource to transmit the sidelink message may be selected according to the first indication.

As an example, in response to that the sidelink message is the sidelink discovery message, from a sidelink transmission resource pool indicated by first sidelink transmission resource information, the sidelink transmission resource is selected for transmitting the sidelink message. The first configuration information corresponding to the first sidelink transmission resource information indicates that the sidelink transmission resource is configured to transmit the sidelink discovery message.

As another example, in response to that the sidelink message is the sidelink communication message, from a sidelink transmission resource pool indicated by second sidelink transmission resource information, the sidelink transmission resource is selected for transmitting the sidelink communication message. The first configuration information corresponding to the second sidelink transmission resource information indicates that the sidelink transmission resource is configured to transmit the sidelink communication message.

In the example of the disclosure, the first indication may be configured to indicate that the sidelink transmission resource is merely configured to transmit the sidelink discovery message. In an example, in response to that the sidelink message is the sidelink discovery message, from a sidelink transmission resource pool indicated by sidelink transmission resource information corresponding the first configuration information including the first indication, the sidelink transmission resource is selected for transmitting the sidelink message. In another example, in response to that the sidelink message is the sidelink communication message, from a sidelink transmission resource pool indicated by sidelink transmission resource information corresponding the first configuration information not including the first indication, the sidelink transmission resource is selected for transmitting the sidelink message. In another example, in response to that the sidelink message is the sidelink discovery message, from the sidelink transmission resource pool indicated by the sidelink transmission resource information corresponding the first configuration information not including the first indication, the sidelink transmission resource is selected for transmitting the sidelink message.

In the example of the disclosure, the first indication may be configured to indicate that the sidelink transmission resource is merely configured to transmit the sidelink communication message. In an example, in response to that the sidelink message is the sidelink discovery message, from the sidelink transmission resource pool indicated by the sidelink transmission resource information corresponding the first configuration information not including the first indication, the sidelink transmission resource is selected for transmitting the sidelink message. In another example, in response to that the sidelink message is the sidelink communication message, from a sidelink transmission resource pool indicated by sidelink transmission resource information corresponding the first configuration information not including the first indication, the sidelink transmission resource is selected for transmitting the sidelink message. In another example, in response to that the sidelink message is the sidelink communication message, from a sidelink transmission resource pool indicated by sidelink transmission resource information corresponding the first configuration information including the first indication, the sidelink transmission resource is selected for transmitting the sidelink message.

In summary, the sidelink transmission resource information is received from the network device, where the sidelink transmission resource information at least includes: sidelink transmission resource information on a shared frequency. At least one piece of first configuration information is received from the network device, where the at least one piece of first configuration information corresponds to at least one piece of sidelink transmission resource information. The first configuration information includes: a first indication, configured to indicate whether the sidelink transmission resource is merely configured to transmit a sidelink discovery message or a sidelink communication message. According to the sidelink transmission resource information, a sidelink transmission resource is selected for transmitting a sidelink message. Thus, according to the sidelink transmission resource information and the first configuration information transmitted by the network device, the sidelink transmission resource may be selected by the terminal device for transmitting the sidelink message, such that the sidelink transmission resource on the shared frequency can be utilized, and a resource utilization rate is improved.

An example of the disclosure provides another sidelink communication method. FIG. 4 is a schematic flowchart of another sidelink communication method provided by an example of the disclosure. The sidelink communication method may be performed by a terminal device. A sidelink communication method may be performed separately, or together in conjunction with any example in the disclosure or a possible implementation in the example, or in conjunction with any technical scheme in the related art.

As shown in FIG. 4, the sidelink communication method may include the following steps.
Step 401, sidelink transmission resource information is received from a network device, where the sidelink transmission resource information at least includes: sidelink transmission resource information on a shared frequency.

At least one piece of sidelink transmission resource information is provided. The at least one piece of sidelink transmission resource information may include: sidelink transmission resource information on the shared frequency and sidelink transmission resource information on an unshared frequency.

In the example of the disclosure, a plurality of pieces of sidelink transmission resource information are provided. One piece of sidelink transmission resource information includes a plurality of time-frequency resource locations. That is, a plurality of sidelink transmission resource pools are provided and include sidelink transmission resource pools on the shared frequency and sidelink transmission resource pools on the unshared frequency, and one sidelink transmission resource pool includes a plurality of sidelink transmission resources for transmitting sidelink messages.
Step 402, at least one piece of second configuration information is received from the network device, where the at least one piece of second configuration information corresponds to at least one piece of sidelink transmission resource information on the shared frequency.

The second configuration information includes: a use condition, where the use condition includes at least one of the following conditions: a service attribute condition, configured to indicate that a service attribute of a sidelink message needs to be consistent with a service attribute corresponding to the service attribute condition; a Reference Signal Received Power (RSRP) threshold value and a corresponding first judgment condition, configured to indicate that a magnitude relationship between an RSRP value of the terminal device and the RSRP threshold value needs to meet the first judgment condition; a CBR threshold value and a corresponding second judgment condition, configured to indicate that a magnitude relationship between a CBR value measured by the terminal device and the CBR threshold value needs to meet the second judgment condition; where the CBR value is a CBR value measured by the terminal device for the sidelink transmission resource pool indicated by the sidelink transmission resource information; or a geographic location condition, configured to indicate that a geographic location where the terminal device is located needs to be consistent with a geographic location corresponding to the geographic location condition.

In an example, the service attribute condition may be a 5G QoS identifier (5QI). In another example, the service attribute condition may be a transmission file. The transmission file is configured to indicate the terminal device to use which version of protocol for transmission, or use which feature for transmission. The feature may be whether to start sidelink discontinuous reception (DRX). In another example, the service attribute condition may include the 5QI and the transmission file.

The first judgment condition is that the RSRP value of the terminal device is greater than or equal to the RSRP threshold value, or the RSRP value of the terminal device is less than the RSRP threshold value. The second judgment condition is that the CBR value of the terminal device is greater than or equal to the CBR threshold value, or the CBR value of the terminal device is less than the CBR threshold value.

When the magnitude relationship between the RSRP value of the terminal device and the RSRP threshold value meets the first judgment condition, it is indicated that the RSRP threshold value and the corresponding first judgment condition are met. When the magnitude relationship between the CBR value of the terminal device and the CBR threshold value meets the second judgment condition, it is indicated that the CBR threshold value and the corresponding second judgment condition are met.

The first judgment condition may be configured in other modes without being configured in the second configuration information, such as advance configuration or protocol configuration. The second judgment condition may be configured in other modes without being configured in the second configuration information, such as advance configuration or protocol configuration.

The CBR value is measured for the sidelink transmission resource pool indicated by the sidelink transmission resource information on the shared frequency; or the CBR value is measured for the sidelink transmission resource pool indicated by sidelink transmission resource information on an unshared frequency.

When the use condition corresponding to the sidelink transmission resource information on the shared frequency includes the CBR threshold value and the corresponding second judgment condition, the CBR value may be measured for the sidelink transmission resource pool indicated by the sidelink transmission resource information on the unshared frequency, and may also be measured for the sidelink transmission resource pool indicated by the sidelink transmission resource information on the shared frequency.

When the geographic location where the terminal device is located needs to be consistent with the geographic location corresponding to the geographic location condition, it is indicated that the geographic location condition in the use condition is met.

In the example of disclosure, the second configuration information corresponds to the sidelink transmission resource information on the shared frequency. In an example, at least one piece of second configuration information may be in one-to-one correspondence with at least one piece of sidelink transmission resource information. In another example, one piece of second configuration information may correspond to one piece of sidelink transmission resource information, and may also correspond to a plurality of pieces of sidelink transmission resource information. A plurality of pieces of sidelink transmission resource information on the shared frequency are provided. A plurality of pieces of second configuration information are also provided. Each piece of second configuration information includes one use condition.
Step 403, according to the sidelink transmission resource information and the second configuration information, a sidelink transmission resource is selected for transmitting a sidelink message.

In an example, in response to that the use condition is included in the at least one piece of second configuration information and is met, from the sidelink transmission resource pool indicated by a sidelink transmission resource message, that corresponds to the second configuration information whose included use condition is met, on the shared frequency, the sidelink transmission resource is selected for transmitting the sidelink message.

In another example, in response to that the use conditions are included in the at least one piece of second configuration information, and the included use conditions are not met, from a sidelink transmission resource pool indicated by sidelink transmission resource information on an unshared frequency, the sidelink transmission resource is selected for transmitting the sidelink message.

In the example of the disclosure, the plurality of use conditions are provided. When a certain use condition is met, from the sidelink transmission resource pool indicated by the sidelink transmission resource message, that corresponds to the second configuration information that includes the use condition, on the shared frequency, the sidelink transmission resource is selected for transmitting the sidelink message. When the plurality of use conditions are not met, from the sidelink transmission resource pool indicated by the sidelink transmission resource information on the unshared frequency, the sidelink transmission resource is selected for transmitting the sidelink message.

In summary, the sidelink transmission resource information is received by the terminal device from the network device, where the sidelink transmission resource information at least includes: the sidelink transmission resource information on the shared frequency. The at least one piece of second configuration information is received from the network device, where the at least one piece of second configuration information corresponds to the at least one piece of sidelink transmission resource information on the shared frequency. According to the sidelink transmission resource information, the sidelink transmission resource is selected for transmitting the sidelink message, Thus, according to the sidelink transmission resource information and the second configuration information transmitted by the network device, the sidelink transmission resource may be selected by the terminal device for transmitting the sidelink message, such that the sidelink transmission resource on the shared frequency can be utilized, and a resource utilization rate is improved.

An example of the disclosure provides another sidelink communication method. FIG. 5 is a schematic flowchart of another sidelink communication method provided by an example of the disclosure. The sidelink communication method may be performed by a terminal device. The sidelink communication method may be performed separately, or together in conjunction with any example in the disclosure or a possible implementation in the example, or in conjunction with any technical scheme in the related art.
Step 501, sidelink transmission resource information is received from a network device, where the sidelink transmission resource information at least includes: sidelink transmission resource information on a shared frequency.

At least one piece of sidelink transmission resource information is provided. The at least one piece of sidelink transmission resource information may include: sidelink transmission resource information on the shared frequency and sidelink transmission resource information on an unshared frequency.

In the example of the disclosure, a plurality of pieces of sidelink transmission resource information are provided. One piece of sidelink transmission resource information includes a plurality of time-frequency resource locations. That is, a plurality of sidelink transmission resource pools are provided and include sidelink transmission resource pools on the shared frequency and sidelink transmission resource pools on the unshared frequency, and one sidelink transmission resource pool includes a plurality of sidelink transmission resources for transmitting sidelink messages.
Step 502, third configuration information is received from the network device.

In an example, the third configuration information is configured to indicating whether a sidelink message from a sidelink logical channel or a bearer can be transmitted on a sidelink transmission resource on the shared frequency.

In another example, the third configuration information is configured to indicating whether a sidelink message to be transmitted to a destination terminal device can be transmitted on the sidelink transmission resource on the shared frequency.
Step 503, according to the sidelink transmission resource information and the third configuration information, a sidelink transmission resource is selected for transmitting a sidelink message.

In an example, in response to that the sidelink message comes from a first sidelink logical channel or the bearer, from a sidelink transmission resource pool indicated by the sidelink transmission resource information on the shared frequency, the sidelink transmission resource is selected for transmitting the sidelink message. The third configuration information indicates that the sidelink message from the first sidelink logical channel or the bearer can be transmitted on the sidelink transmission resource on the shared frequency.

In another example, in response to that the destination terminal device for the sidelink message is a first destination terminal device, from the sidelink transmission resource pool indicated by the sidelink transmission resource information on the shared frequency, the sidelink transmission resource is selected for transmitting the sidelink message. The third configuration information indicates that the sidelink message to be transmitted to the first destination terminal device can be transmitted on the sidelink transmission resource on the shared frequency.

In another example, in response to that a transmission resource on the shared frequency scheduled by the network device is received by the terminal device, and that the sidelink message comes from the first sidelink logical channel or the bearer, the sidelink message is transmitted by the transmission resource on the shared frequency scheduled by the network device. The third configuration information indicates that the sidelink message from the first sidelink logical channel or the bearer can be transmitted on the sidelink transmission resource on the shared frequency.

In another example, in response to that the transmission resource on the shared frequency scheduled by the network device is received by the terminal device, and that the destination terminal device for the sidelink message is the first destination terminal device, the sidelink message is transmitted by the transmission resource on the shared frequency scheduled by the network device. The third configuration information indicates that the sidelink message to be transmitted to the first destination terminal device can be transmitted on the sidelink transmission resource on the shared frequency.

In summary, the sidelink transmission resource information is received from the network device, where the sidelink transmission resource information at least includes: the sidelink transmission resource information on the shared frequency. The third configuration information is received from the network device. According to the sidelink transmission resource information, the sidelink transmission resource is selected for transmitting the sidelink message. Thus, according to the sidelink transmission resource information and the third configuration information transmitted by the network device, the sidelink transmission resource may be selected by the terminal device for transmitting the sidelink message, such that the sidelink transmission resource on the shared frequency can be utilized, and a resource utilization rate is improved.

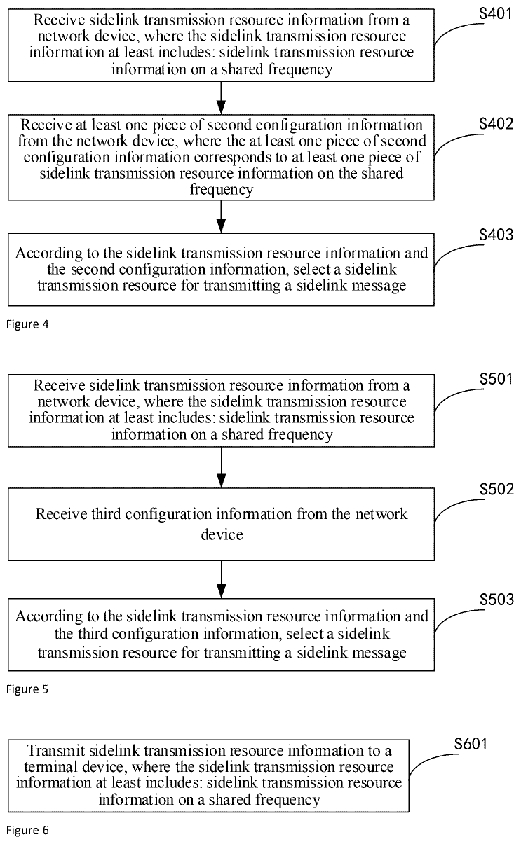

An example of the disclosure provides a sidelink communication method. FIG. 6 is a schematic flowchart of another sidelink communication method provided by an example of the disclosure. The sidelink communication method may be performed by a network device. The sidelink communication method may be performed by the network device in FIG. 1.

As shown in FIG. 6, the sidelink communication method may include the following steps.
Step 601, sidelink transmission resource information is transmitted to a terminal device, where the sidelink transmission resource information at least includes: sidelink transmission resource information on a shared frequency.

The sidelink transmission resource information is configured to indicate a sidelink transmission resource pool for transmission of a sidelink message. The sidelink transmission resource information includes: at least one time-frequency resource location, and the at least one time-frequency resource location is configured to indicate the sidelink transmission resource in the sidelink transmission resource pool.

At least one piece of sidelink transmission resource information is provided. The at least one piece of sidelink transmission resource information may include: the sidelink transmission resource information on the shared frequency and sidelink transmission resource information on an unshared frequency.

One piece of sidelink transmission resource information may be configured to indicate one sidelink transmission resource pool for the transmission of the sidelink message. At least one piece of sidelink transmission resource information is provided. At least one sidelink transmission resource pool is provided. One sidelink transmission resource pool includes at least one time-frequency resource location. The at least one time-frequency resource location is configured to indicate one sidelink transmission resource in the sidelink transmission resource pool.

In an example, a system broadcast message is transmitted to the terminal device in an inactive state or an idle state by the network device, where the sidelink transmission resource information is carried in the system broadcast message. One system broadcast message may be provided. A plurality of pieces of sidelink transmission resource information may be transmitted by the network device through the one system broadcast message. A plurality of system broadcast messages may be provided. A plurality of pieces of sidelink transmission resource information may be transmitted by the network device through the plurality of system broadcast messages.

In another example, an RRC message is transmitted to the terminal device in a connected state by the network device, where the sidelink transmission resource information is carried in the RRC message. One RRC message may be provided. A plurality of pieces of sidelink transmission resource information is transmitted by the network device through the one RRC message. A plurality of RRC messages may be provided. A plurality of pieces of sidelink transmission resource information is transmitted by the network device through the plurality of RRC messages.

In the example of the disclosure, before the sidelink transmission resource information on the shared frequency is transmitted to the terminal device in a connected state, a capability indication reported by the terminal device is received by the network device. The capability indication is configured to indicate whether the terminal device supports transmission of a sidelink message by adopting the sidelink transmission resource on the shared frequency.

In an example, the capability indication may be configured to indicate that user equipment supports that sidelink listen before talk (LBT) is performed on the sidelink transmission resource on the shared frequency. In another example, the capability indication may be configured to indicate that the user equipment supports that a failure detection of sidelink LBT is performed on the sidelink transmission resource on the shared frequency.

The sidelink transmission resource information on the shared frequency is transmitted to the terminal device on a condition that the network device determines that the terminal device supports the transmission of the sidelink message by adopting the sidelink transmission resource on the shared frequency.

Receiving the capability indication reported by the terminal device includes receiving the capability indication reported by the terminal device on at least one frequency band, so that the sidelink transmission resource information on the shared frequency is received by the terminal device with higher accuracy.

In the example of the disclosure, when the terminal device is in an idle state or an inactive state, the capability indication reported by the terminal device does not need to be received by the network device. The system broadcast message may be directly transmitted by the network device. The sidelink transmission resource information carried in the system broadcast message is configured to transmit the sidelink message.

In summary, the sidelink transmission resource information is transmitted to the terminal device by the network device, where the sidelink transmission resource information at least includes: the sidelink transmission resource information on the shared frequency. According to the sidelink transmission resource information transmitted by the network device, the sidelink transmission resource may be selected by the terminal device for transmitting the sidelink message, such that the sidelink transmission resource on the shared frequency can be utilized, and a resource utilization rate is improved.

An example of the disclosure provides another sidelink communication method. FIG. 7 is a schematic flowchart of another sidelink communication method provided by an example of the disclosure. The sidelink communication method may be performed by a network device. The sidelink communication method may be performed by the network device in FIG. 1.

As shown in FIG. 7, the sidelink communication method may include the following steps.
Step 701, sidelink transmission resource information is transmitted to a terminal device, where the sidelink transmission resource information at least includes: sidelink transmission resource information on a shared frequency.

The sidelink transmission resource information is configured to indicate a sidelink transmission resource pool for transmission of a sidelink message. The sidelink transmission resource information includes: at least one time-frequency resource location, and the at least one time-frequency resource location is configured to indicate the sidelink transmission resource in the sidelink transmission resource pool. At least one piece of sidelink transmission resource information may include: the sidelink transmission resource information on the shared frequency and sidelink transmission resource information on an unshared frequency.

One piece of sidelink transmission resource information may be configured to indicate one sidelink transmission resource pool for the transmission of the sidelink message. At least one piece of sidelink transmission resource information is provided. At least one sidelink transmission resource pool is provided. One sidelink transmission resource pool includes at least one time-frequency resource location. The at least one time-frequency resource location is configured to indicate one sidelink transmission resource in the sidelink transmission resource pool.
Step 702, at least one piece of first configuration information is transmitted to the terminal device, where the at least one piece of first configuration information corresponds to at least one piece of sidelink transmission resource information. The first configuration information includes: a first indication, configured to indicate whether the sidelink transmission resource is configured to transmit a sidelink discovery message or a sidelink communication message.

In the example of the disclosure, a plurality of pieces of sidelink transmission resource information are transmitted to the terminal device by the network device. The first configuration information corresponds to the sidelink transmission resource information. In an example, the at least one piece of first configuration information may be in one-to-one correspondence with the at least one piece of sidelink transmission resource information. In another example, one piece of first configuration information may correspond to one piece of sidelink transmission resource information, and may also correspond to a plurality of pieces of sidelink transmission resource information. A plurality of pieces of sidelink transmission resource information are provided. A plurality of pieces of corresponding first configuration information are provided.

In an example, in at least one piece of first configuration information, part of the first configuration information may include a first indication, and part of the first configuration information may not include the first indication. In another example, in at least one piece of first configuration information, all of the first configuration information may not include the first indication.

In summary, the sidelink transmission resource information is transmitted to the terminal device by the network device, where the sidelink transmission resource information at least includes: the sidelink transmission resource information on the shared frequency. At least one piece of first configuration information is transmitted to the terminal device, where the at least one piece of first configuration information corresponds to at least one piece of sidelink transmission resource information. The first configuration information includes: a first indication, configured to indicate whether the sidelink transmission resource is configured to transmit a sidelink discovery message or a sidelink communication message. Thus, according to the sidelink transmission resource information and the first configuration information transmitted by the network device, the sidelink transmission resource may be selected by the terminal device for transmitting the sidelink message, such that the sidelink transmission resource on the shared frequency can be utilized, and a resource utilization rate is improved.

An example of the disclosure provides another sidelink communication method. FIG. 8 is a schematic flowchart of another sidelink communication method provided by an example of the disclosure. The sidelink communication method may be performed by a network device. The sidelink communication method may be performed separately, or together in conjunction with any example in the disclosure or a possible implementation in the example, or in conjunction with any technical scheme in the related art.

As shown in FIG. 8, the sidelink communication method may include the following steps.
Step 801, sidelink transmission resource information is transmitted to a terminal device, where the sidelink transmission resource information at least includes: sidelink transmission resource information on a shared frequency.

The sidelink transmission resource information is configured to indicate a sidelink transmission resource pool for transmission of a sidelink message. The sidelink transmission resource information includes: at least one time-frequency resource location, and the at least one time-frequency resource location is configured to indicate a sidelink transmission resource in the sidelink transmission resource pool. At least one piece of sidelink transmission resource information may include: the sidelink transmission resource information on the shared frequency and sidelink transmission resource information on an unshared frequency.

One piece of sidelink transmission resource information may be configured to indicate one sidelink transmission resource pool for the transmission of the sidelink message. At least one piece of sidelink transmission resource information is provided. At least one sidelink transmission resource pool is provided. One sidelink transmission resource pool includes at least one time-frequency resource location. The at least one time-frequency resource location is configured to indicate one sidelink transmission resource in the sidelink transmission resource pool.
Step 802, at least one piece of second configuration information is transmitted to the terminal device, where the at least one piece of second configuration information corresponds to at least one piece of sidelink transmission resource information on the shared frequency.

The second configuration information includes: a use condition, where the use condition includes at least one of the following conditions: a service attribute condition, configured to indicating that a service attribute of a sidelink message needs to be consistent with a service attribute corresponding to the service attribute condition; an RSRP threshold value and a corresponding first judgment condition, configured to indicate that a magnitude relationship between an RSRP value of the terminal device and the RSRP threshold value needs to meet the first judgment condition; a CBR threshold value and a corresponding second judgment condition, configured to indicate that a magnitude relationship between a CBR value measured by the terminal device and the CBR threshold value needs to meet the second judgment condition; where the CBR value is a CBR value measured by the terminal device for the sidelink transmission resource pool indicated by the sidelink transmission resource information; or a geographic location condition, configured to indicate that a geographic location where the terminal device is located needs to be consistent with a geographic location corresponding to the geographic location condition.

In an example, the service attribute condition may be a 5G QoS identifier (5QI). In another example, the service attribute condition may be a transmission file. The transmission file is configured to indicate the terminal device to use which version of protocol for transmission, or use which feature for transmission. The feature may be whether to start sidelink discontinuous reception (DRX). In another example, the service attribute condition may include the 5QI and the transmission file.

The first judgment condition is that the RSRP value of the terminal device is greater than or equal to the RSRP threshold value, or the RSRP value of the terminal device is less than the RSRP threshold value. The second judgment condition is that the CBR value of the terminal device is greater than or equal to the CBR threshold value, or the CBR value of the terminal device is less than the CBR threshold value.

When the magnitude relationship between the RSRP value of the terminal device and the RSRP threshold value meets the first judgment condition, it is indicated that the RSRP threshold value and the corresponding first judgment condition are met. When the magnitude relationship between the CBR value of the terminal device and the CBR threshold value meets the second judgment condition, it is indicated that the CBR threshold value and the corresponding second judgment condition are met.

The first judgment condition may be configured in other modes without being configured in the second configuration information, such as advance configuration or protocol configuration. The second judgment condition may be configured in other modes without being configured in the second configuration information, such as advance configuration or protocol configuration.

The CBR value is measured for the sidelink transmission resource pool indicated by the sidelink transmission resource information on the shared frequency; or the CBR value is measured for the sidelink transmission resource pool indicated by sidelink transmission resource information on an unshared frequency.

When the use condition corresponding to the sidelink transmission resource information on the shared frequency includes the CBR threshold value and the corresponding second judgment condition, the CBR value may be measured for the sidelink transmission resource pool indicated by the sidelink transmission resource information on the unshared frequency, and may also be measured for the sidelink transmission resource pool indicated by the sidelink transmission resource information on the shared frequency.

When the geographic location where the terminal device is located needs to be consistent with the geographic location corresponding to the geographic location condition, it is indicated that the geographic location condition in the use condition is met.

In the example of disclosure, the second configuration information corresponds to the sidelink transmission resource information on the shared frequency. In an example, at least one piece of second configuration information may be in one-to-one correspondence with at least one piece of sidelink transmission resource information. In another example, one piece of second configuration information may correspond to one piece of sidelink transmission resource information, and may also correspond to a plurality of pieces of sidelink transmission resource information. A plurality of pieces of sidelink transmission resource information on the shared frequency are provided. A plurality of pieces of second configuration information are also provided. Each piece of second configuration information includes one use condition.

In summary, the sidelink transmission resource information is transmitted to the terminal device by the network device, where the sidelink transmission resource information at least includes: the sidelink transmission resource information on the shared frequency. At least one piece of second configuration information is transmitted to the terminal device, where the at least one piece of second configuration information corresponds to at least one piece of sidelink transmission resource information on the shared frequency. Thus, according to the sidelink transmission resource information and the first configuration information transmitted by the network device, the sidelink transmission resource may be selected by the terminal device for transmitting the sidelink message, such that the sidelink transmission resource on the shared frequency can be utilized, and a resource utilization rate is improved.

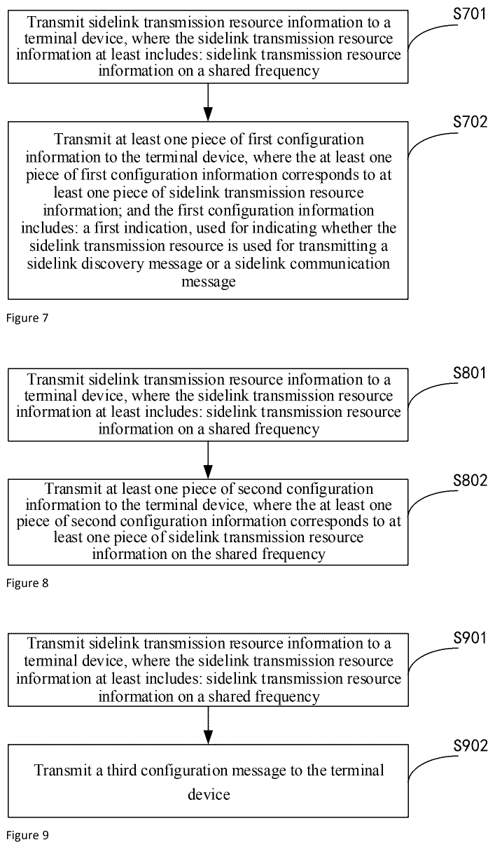

An example of the disclosure provides another sidelink communication method. FIG. 9 is a schematic flowchart of another sidelink communication method provided by an example of the disclosure. The sidelink communication method may be performed by a network device. The sidelink communication method may be performed separately, or together in conjunction with any example in the disclosure or a possible implementation in the example, or in conjunction with any technical scheme in the related art.

As shown in FIG. 9, the sidelink communication method may include the following steps.
Step 901, sidelink transmission resource information is transmitted to a terminal device, where the sidelink transmission resource information at least includes: sidelink transmission resource information on a shared frequency.

The sidelink transmission resource information is configured to indicate a sidelink transmission resource pool for transmission of a sidelink message. The sidelink transmission resource information includes: at least one time-frequency resource location, and the at least one time-frequency resource location is configured to indicate a sidelink transmission resource in the sidelink transmission resource pool. At least one piece of sidelink transmission resource information may include: the sidelink transmission resource information on the shared frequency and sidelink transmission resource information on an unshared frequency.

One piece of sidelink transmission resource information may be configured to indicate one sidelink transmission resource pool for the transmission of the sidelink message. At least one piece of sidelink transmission resource information is provided. At least one sidelink transmission resource pool is provided. One sidelink transmission resource pool includes at least one time-frequency resource location. The at least one time-frequency resource location is configured to indicate one sidelink transmission resource in the sidelink transmission resource pool.
Step 902, third configuration information is transmitted to the terminal device.

In an example, the third configuration information is configured to indicate whether a sidelink message from a sidelink logical channel or a bearer can be transmitted on a sidelink transmission resource on the shared frequency.

In another example, the third configuration information is configured to indicate whether a sidelink message to be transmitted to a destination terminal device can be transmitted on the sidelink transmission resource on the shared frequency.

It needs to be noted that the explanation of the sidelink communication method executed by the terminal device in any foregoing example is also applicable to the sidelink communication method performed by the network device, and its implementation principle is similar, so it will not be repeated here.

In summary, the sidelink transmission resource information is transmitted to the terminal device by the network device, where the sidelink transmission resource information at least includes: the sidelink transmission resource information on the shared frequency. The third configuration information is transmitted to the terminal device. Thus, according to the sidelink transmission resource information and the third configuration information transmitted by the network device, the sidelink transmission resource may be selected by the terminal device for transmitting the sidelink message, such that the sidelink transmission resource on the shared frequency can be utilized, and a resource utilization rate is improved.

It needs to be noted that these possible implementations above may be performed separately or in combination, which is not limited by the example of the disclosure.

In the above examples provided in the disclosure, the methods provided in the examples of the disclosure are introduced from the perspectives of the terminal device and the network device. In order to implement the functions in the methods provided by the above examples of the disclosure, the terminal device and the network device may include a hardware structure and a software module to implement the above functions in the form of the hardware structure, the software module, or a hardware structure plus a software module. A certain function of the above functions may be performed in the form of the hardware structure, the software module or the hardware structure plus the software module.

Corresponding to the sidelink communication methods provided by the above examples of FIG. 2 to FIG. 5, the disclosure further provides a sidelink communication apparatus. Because the sidelink communication apparatus provided by the example of the disclosure corresponds to the sidelink communication methods provided by the above examples of FIG. 2 to FIG. 5, the implementations of the sidelink communication methods are also applicable to the sidelink communication apparatus provided by the example of the disclosure, which is not described in detail in the example of the disclosure.

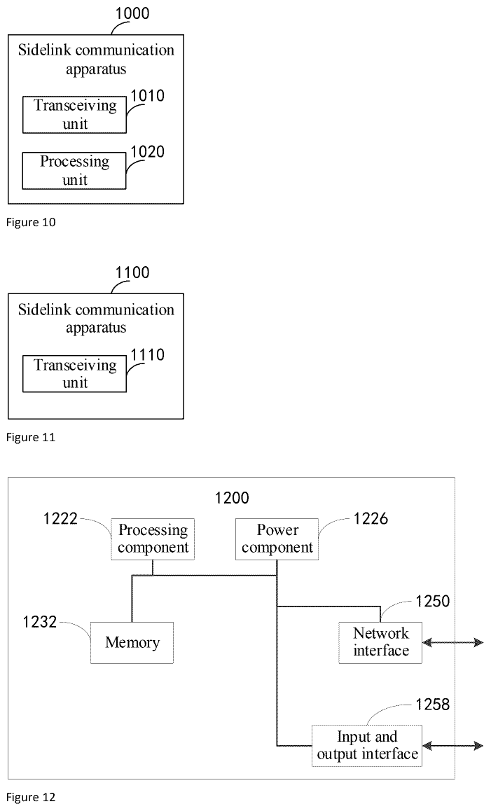

FIG. 10 is a schematic structural diagram of a sidelink communication apparatus provided by an example of the disclosure. The sidelink communication apparatus is performed by a terminal device.

As shown in FIG. 10, the sidelink communication apparatus 1000 includes a transceiving unit 1010 and a processing unit 1020.

The transceiving unit 1010 is configured to receive sidelink transmission resource information from a network device, where the sidelink transmission resource information at least includes: sidelink transmission resource information on a shared frequency. The processing unit 1020 is configured to select, according to the sidelink transmission resource information, a sidelink transmission resource for transmitting a sidelink message.

As a possible implementation of the example of the disclosure, the transceiving unit 1010 is further configured to receive, in response to that the terminal device is in an inactive state or an idle state, a system broadcast message from the network device, where the sidelink transmission resource information is carried in the system broadcast message. Or, the transceiving unit 1010 is further configured to receive, in response to that terminal device is in a connected state, an RRC message from the network device, where the sidelink transmission resource information is carried in the RRC message.

As a possible implementation of the example of the disclosure, the sidelink transmission resource information is configured to indicating a sidelink transmission resource pool for transmission of the sidelink message. The sidelink transmission resource information includes: at least one time-frequency resource location, and the at least one time-frequency resource location is configured to indicating a sidelink transmission resource in the sidelink transmission resource pool.

As a possible implementation of the example of the disclosure, the transceiving unit 1010 is further configured to receive at least one piece of first configuration information from the network device, where the at least one piece of first configuration information corresponds to the at least one piece of sidelink transmission resource information. The first configuration information includes: a first indication, configured to indicating whether the sidelink transmission resource is configured to transmitting a sidelink discovery message or a sidelink communication message. The processing unit 1020 is further configured to select, from a sidelink transmission resource pool indicated by first sidelink transmission resource information, the sidelink transmission resource for transmitting the sidelink message. The first configuration information corresponding to the first sidelink transmission resource information indicates that the sidelink transmission resource is configured to transmit the sidelink discovery message. Or, the processing unit 1020 is further configured to select, in response to that the sidelink message is the sidelink communication message, from a sidelink transmission resource pool indicated by second sidelink transmission resource information, the sidelink transmission resource for transmitting the sidelink message. The first configuration information corresponding to the second sidelink transmission resource information indicates that the sidelink transmission resource is configured to transmit the sidelink communication message.

As a possible implementation of the example of the disclosure, the transceiving unit 1010 is further configured to receive at least one piece of second configuration information from the network device, where the at least one piece of second configuration information corresponds to at least one piece of sidelink transmission resource information on the shared frequency. The second configuration information includes: a use condition, where the use condition includes at least one of the following conditions: a service attribute condition, configured to indicate that a service attribute of a sidelink message needs to be consistent with a service attribute corresponding to the service attribute condition; an RSRP threshold value and a corresponding first judgment condition, configured to indicate that a magnitude relationship between an RSRP value of the terminal device and the RSRP threshold value needs to meet the first judgment condition; a CBR threshold value and a corresponding second judgment condition, configured to indicate that a magnitude relationship between a CBR value measured by the terminal device and the CBR threshold value needs to meet the second judgment condition; where the CBR value is a CBR value measured by the terminal device for the sidelink transmission resource pool indicated by the sidelink transmission resource information; or a geographic location condition, configured to indicate that a geographic location where the terminal device is located needs to be consistent with a geographic location corresponding to the geographic location condition.

As a possible implementation of the example of the disclosure, the processing unit 1020 is further configured to select, in response to that the use condition is included in the at least one piece of second configuration information and is met, from the sidelink transmission resource pool indicated by a sidelink transmission resource message, that corresponds to the second configuration information whose included use condition is met, on the shared frequency, the sidelink transmission resource for transmitting the sidelink message. Or, the processing unit 1020 is further configured to select, in response to that the use conditions are included in the at least one second configuration information, and the included use conditions are not met, from a sidelink transmission resource pool indicated by sidelink transmission resource information on an unshared frequency, the sidelink transmission resource for transmitting the sidelink message.

As a possible implementation of the example of the disclosure, the first judgment condition is that the RSRP value of the terminal device is greater than or equal to the RSRP threshold value, or the RSRP value of the terminal device is less than the RSRP threshold value. The second judgment condition is that the CBR value of the terminal device is greater than or equal to the CBR threshold value, or the CBR value of the terminal device is less than the CBR threshold value. The CBR value is measured for the sidelink transmission resource pool indicated by the sidelink transmission resource information on the shared frequency; or the CBR value is measured for the sidelink transmission resource pool indicated by sidelink transmission resource information on an unshared frequency.

As a possible implementation of the example of the disclosure, the terminal device is in a connected state, and the transceiving unit 1010 is further configured to report a capability indication to the network device. The capability indication is configured to indicate whether the terminal device supports transmission of the sidelink message by adopting a sidelink transmission resource on the shared frequency. The sidelink transmission resource information on the shared frequency is transmitted to the terminal device on a condition that the network device determines that the terminal device supports the transmission of the sidelink message by adopting the sidelink transmission resource on the shared frequency.

As a possible implementation of the example of the disclosure, reporting the capability indication to the network device includes reporting the capability indication to the network device on at least one frequency band.

As a possible implementation of the example of the disclosure, the transceiving unit 1010 is further configured to receive third configuration information from the network device. The third configuration information is configured to indicate whether a sidelink message from a sidelink logical channel or a bearer can be transmitted on a sidelink transmission resource on the shared frequency. Or, the third configuration information is configured to indicate whether a sidelink message to be transmitted to a destination terminal device can be transmitted on the sidelink transmission resource on the shared frequency.

As a possible implementation of the example of the disclosure, the processing unit 1020 is further configured to select, in response to that the sidelink message comes from a first sidelink logical channel or a bearer, from a sidelink transmission resource pool indicated by the sidelink transmission resource information on the shared frequency, the sidelink transmission resource for transmitting the sidelink message. The third configuration information indicates that the sidelink message from the first sidelink logical channel or the bearer can be transmitted on the sidelink transmission resource on the shared frequency.

As a possible implementation of the example of the disclosure, the processing unit 1020 is further configured to select, in response to that the destination terminal device for the sidelink message is a first destination terminal device, from a sidelink transmission resource pool indicated by the sidelink transmission resource information on the shared frequency, the sidelink transmission resource for transmitting the sidelink message. The third configuration information indicates that the sidelink message to be transmitted to the first destination terminal device can be transmitted on the sidelink transmission resource on the shared frequency.

As a possible implementation of the example of the disclosure, the processing unit 1020 is further configured to transmit, in response to that a transmission resource on the shared frequency scheduled by the network device is received by the terminal device, and that the sidelink message comes from the first sidelink logical channel or the bearer, the sidelink message by the transmission resource on the shared frequency scheduled by the network device. The third configuration information indicates that the sidelink message from the first sidelink logical channel or the bearer can be transmitted on the sidelink transmission resource on the shared frequency.

As a possible implementation of the example of the disclosure, the processing unit 1020 is further configured to transmit, in response to that the transmission resource on the shared frequency scheduled by the network device is received by the terminal device, and that the destination terminal device for the sidelink message is the first destination terminal device, the sidelink message by the transmission resource on the shared frequency scheduled by the network device. The third configuration information indicates that the sidelink message to be transmitted to the first destination terminal device can be transmitted on the sidelink transmission resource on the shared frequency.

The sidelink communication apparatus of the example of the disclosure is performed by the terminal device, and the sidelink transmission resource information from the network device is received. The sidelink transmission resource information at least includes: the sidelink transmission resource information on the shared frequency. According to the sidelink transmission resource information, the sidelink transmission resource is selected for transmitting the sidelink message, such that the sidelink transmission resource on the shared frequency can be utilized, and a resource utilization rate is improved.

Corresponding to the sidelink communication method provided by the above example of FIG. 6, the disclosure further provides a sidelink communication apparatus. Because the sidelink communication apparatus provided by the example of the disclosure corresponds to the sidelink communication method provided by the above example of FIG. 6, the implementation of the sidelink communication method is also applicable to the sidelink communication apparatus provided by the example of the disclosure, which is not described in detail in the example of the disclosure.

FIG. 11 is a schematic structural diagram of another sidelink communication apparatus provided by an example of the disclosure. The sidelink communication apparatus is performed by a network device.

As shown in FIG. 11, the sidelink communication apparatus 1100 includes a transceiving unit 1110.

The transceiving unit 1110 is configured to transmit sidelink transmission resource information to a terminal device, where the sidelink transmission resource information at least includes: sidelink transmission resource information on a shared frequency.

As a possible implementation of the example of the disclosure, the transceiving unit 1110 is further configured to transmit a system broadcast message to the terminal device in an inactive state or an idle state, where the sidelink transmission resource information is carried in the system broadcast message. Or, the transceiving unit 1110 is further configured to transmit an RRC message to the terminal device in a connected state, where sidelink transmission resource information is carried in the RRC message.

As a possible implementation of the example of the disclosure, the sidelink transmission resource information is configured to indicate a sidelink transmission resource pool for transmission of the sidelink message. The sidelink transmission resource information includes: at least one time-frequency resource location, and the at least one time-frequency resource location is configured to indicate a sidelink transmission resource in the sidelink transmission resource pool.

As a possible implementation of the example of the disclosure, the transceiving unit 1110 is further configured to transmit at least one piece of first configuration information to the terminal device, where the at least one piece of first configuration information corresponds to at least one piece of sidelink transmission resource information. The first configuration information includes: a first indication, configured to indicate whether the sidelink transmission resource is configured to transmit a sidelink discovery message or a sidelink communication message.

As a possible implementation of the example of the disclosure, the transceiving unit 1110 is further configured to transmit at least one piece of second configuration information to the terminal device, where the at least one piece of second configuration information corresponds to at least one piece of sidelink transmission resource information on the shared frequency. The second configuration information includes: a use condition, where the use condition includes at least one of the following conditions: a service attribute condition, configured to indicate that a service attribute of a sidelink message needs to be consistent with a service attribute corresponding to the service attribute condition; an RSRP threshold value and a corresponding first judgment condition, configured to indicate that a magnitude relationship between an RSRP value of the terminal device and the RSRP threshold value needs to meet the first judgment condition; a CBR threshold value and a corresponding second judgment condition, configured to indicate that a magnitude relationship between a CBR value measured by the terminal device and the CBR threshold value needs to meet the second judgment condition; where the CBR value is a CBR value measured by the terminal device for the sidelink transmission resource pool indicated by the sidelink transmission resource information; or a geographic location condition, configured to indicate that a geographic location where the terminal device is located needs to be consistent with a geographic location corresponding to the geographic location condition.

As a possible implementation of the example of the disclosure, the first judgment condition is that the RSRP value of the terminal device is greater than or equal to the RSRP threshold value, or the RSRP value of the terminal device is less than the RSRP threshold value. The second judgment condition is that the CBR value of the terminal device is greater than or equal to the CBR threshold value, or the CBR value of the terminal device is less than the CBR threshold value. The CBR value is measured for the sidelink transmission resource pool indicated by the sidelink transmission resource information on the shared frequency; or the CBR value is measured for the sidelink transmission resource pool indicated by sidelink transmission resource information on an unshared frequency.

As a possible implementation of the example of the disclosure, the transceiving unit 1110 is further configured to receive a capability indication reported by the terminal device. The capability indication is configured to indicate whether the terminal device supports transmission of a sidelink message by adopting the sidelink transmission resource on the shared frequency. The sidelink transmission resource information on the shared frequency is transmitted to the terminal device on a condition that the network device determines that the terminal device supports the transmission of the sidelink message by adopting the sidelink transmission resource on the shared frequency.

As a possible implementation of the example of the disclosure, receiving the capability indication reported by the terminal device includes receiving the capability indication reported by the terminal device on at least one frequency band.

As a possible implementation of the example of the disclosure, the transceiving unit 1110 is further configured to transmit third configuration information to the terminal device. The third configuration information is configured to indicate whether a sidelink message from a sidelink logical channel or a bearer can be transmitted on a sidelink transmission resource on the shared frequency. Or, the third configuration information is configured to indicate whether a sidelink message to be transmitted to a destination terminal device can be transmitted on the sidelink transmission resource on the shared frequency.

The sidelink communication apparatus of the example of the disclosure is performed by the network device, and the sidelink transmission resource information is transmitted to the terminal device. The sidelink transmission resource information at least includes: sidelink transmission resource information on the shared frequency. According to the sidelink transmission resource information transmitted by the network device, the sidelink transmission resource may be selected by the terminal device for transmitting the sidelink message, such that the sidelink transmission resource on the shared frequency can be utilized, and a resource utilization rate is improved.

In order to implement the above examples, the disclosure further provides a sidelink communication apparatus. The apparatus includes a processor and a memory. A computer program is stored in the memory, and the computer program stored in the memory is executed by the processor so as to enable the apparatus to execute the sidelink communication methods according to the examples of FIG. 2 to FIG. 5.

In order to implement the above examples, the disclosure further provides another sidelink communication apparatus. The apparatus includes a processor and a memory. A computer program is stored in the memory, and the computer program stored in the memory is executed by the processor so as to enable the apparatus to execute the sidelink communication methods according to the examples of FIG. 6 to FIG. 9.

In order to implement the above examples, the disclosure further provides a sidelink communication apparatus, including: a processor and an interface circuit. The interface circuit is configured to receive a code instruction and transmit the code instruction to the processor. The processor is configured to run the code instruction so as to execute the sidelink communication methods according to the examples of FIG. 2 to FIG. 5.

In order to implement the above examples, the disclosure further provides another sidelink communication apparatus, including: a processor and an interface circuit. The interface circuit is configured to receive a code instruction and transmitting the code instruction to the processor. The processor is configured to run the code instruction so as to execute the sidelink communication methods according to the examples of FIG. 6 to FIG. 9.

In order to implement the above examples, the disclosure further provides a computer readable storage medium, configured to store an instruction. When the instruction is executed, the sidelink communication methods according to the examples of FIG. 2 to FIG. 5 are implemented.

In order to implement the above examples, the disclosure further provides another computer readable storage medium, configured to store an instruction. When the instruction is executed, the sidelink communication methods according to the examples of FIG. 6 to FIG. 9 are implemented.

As shown in FIG. 12, FIG. 12 is a schematic structural diagram of a network device provided by an example of the disclosure. Referring to FIG. 12, the network device 1200 includes a processing component 1222, which further includes at least one processor, and a memory resource represented by a memory 1232 for storing instructions, such as applications, that can be executed by the processing component 1222. The applications stored in the memory 1232 may include one or more modules each corresponding to a set of instructions. In addition, the processing component 1222 is configured to execute instructions to execute any method performed by the network device above, such as the methods of the examples of FIG. 6 to FIG. 9.

The network device 1200 may further include a power component 1226 configured to execute power management of the network device 1200, a wired or wireless network interface 1250 configured to connect the network device 1200 to a network, and an input/output (I/O) interface 1258. The network device 1200 may operate an operating system based on the memory 1232, such as Windows Server™, Mac OS X™, Unix™, Linux™, TM FreeBSD™, or the like.

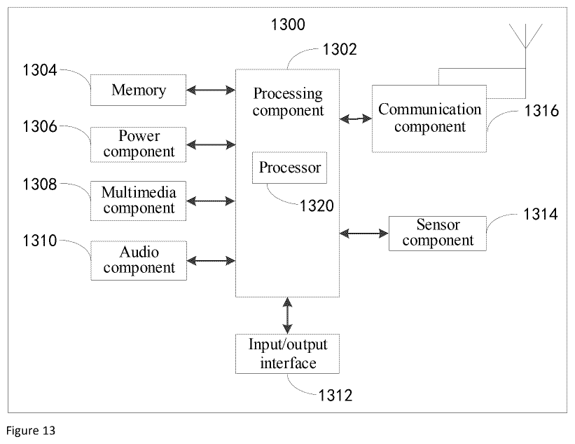

FIG. 13 is a block diagram of a terminal device provided by an example of the disclosure. For example, the terminal device 1300 may be a mobile phone, a computer, digital broadcasting user equipment, a messaging device, a game console, a tablet device, a medical device, a fitness device, a personal digital assistant, etc.

Referring to FIG. 13, the terminal device 1300 may include least one of the following components: a processing component 1302, a memory 1304, a power component 1306, a multimedia component 1308, an audio component 1310, an input/output (I/O) interface 1312, a sensor component 1314, and a communication component 1316.

The processing component 1302 typically controls an overall operation of the terminal device 1300, such as operations associated with display, a telephone call, a data communication, a camera operation, and a recording operation. The processing component 1302 may include at least one processor 1320 to execute instructions to complete all or part of the steps of the above method. In addition, the processing component 1302 may include at least one module to facilitate interaction between the processing component 1302 and other components. For example, the processing component 1302 may include a multimedia module to facilitate interaction between the multimedia component 1308 and the processing component 1302.

The memory 1304 is configured to store various types of data to support operations at the terminal device 1300. Examples of these data include instructions for any application or method operating on the terminal device1300, contact data, phonebook data, messages, pictures, videos, etc. The memory 1304 may be implemented by any type of volatile or nonvolatile storage device or a combination of them, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a magnetic disk or optic disk.

The power component 1306 provides power for various components of the terminal device 1300. The power component 1306 may include a power management system, at least one power source, and other components associated with generating, managing and distributing power for the terminal device 1300.

The multimedia component 1308 includes a screen providing an output interface between the terminal device 1300 and a user. In some examples, the screen may include a liquid crystal display (LCD) and a touch panel (TP). If the screen includes the touch panel, the screen may be implemented as a touch screen to receive an input signal from the user. The touch panel includes at least one touch sensor to sense a touch, sliding and gestures on the touch panel. The touch sensor can not only sense the boundary of the touch or sliding operation, but also detect the waking time and pressure related to the touch or sliding operation. In some examples, the multimedia component 1308 includes a front camera and/or a rear camera. When the terminal device 1300 is in an operation mode, such as a shooting mode or a video mode, the front camera and/or the rear camera can receive external multimedia data. Each front camera and rear camera may be a fixed optical lens system or have a focal length and optical zoom capability.

The audio component 1310 is configured to output and/or input audio signals. For example, the audio component 1310 includes a microphone (MIC) configured to receive an external audio signal when the terminal device 1300 is in the operation mode, such as a call mode, a recording mode, and a speech recognition mode. The received audio signal may be further stored in the memory 1304 or transmitted via the communication component 1316. In some examples, the audio component 1310 further includes a speaker for outputting an audio signal.

The I/O interface 1312 provides an interface between the processing component 1302 and a peripheral interface module which may be a keyboard, a click wheel, a button, etc. These buttons may include but are not limited to: a home button, a volume button, a start button and a lock button.

The sensor component 1314 includes at least one sensor for providing state evaluations of various aspects of the terminal device 1300. For example, the sensor component 1314 may detect an open/closed state of the terminal device 1300 and the relative positioning of the components, for example, the component is a display and a keypad of the terminal device 1300. The sensor component 1314 may also detect a change in the position of the terminal device 1300 or a component of the terminal device 1300, the presence or absence of contact between the user and the terminal device 1300, the orientation or acceleration/deceleration of the terminal device 1300 and the temperature change of the terminal device 1300. The sensor component 1314 may include a proximity sensor configured to detect the presence of nearby objects without any physical contact. The sensor component 1314 may further include an optical sensor, such as a CMOS or CCD image sensor, for use in imaging applications. In some examples, the sensor component 1314 may further include an acceleration sensor, a gyroscope sensor, a magnetic sensor, a pressure sensor, or a temperature sensor.

The communication component 1316 is configured to facilitate wired or wireless communications between the terminal device 1300 and other devices. The terminal device 1300 may access a wireless network based on a communication standard, such as Wi-Fi, 2G or 3G, or their combination. In an example, the communication component 1316 receives a broadcast signal or broadcast-related information from an external broadcast management system via a broadcast channel. In an example, the communication component 1316 further includes a near field communication (NFC) module to facilitate short-range communication. For example, the NFC module may be implemented based on radio frequency identification (RFID) technology, infrared data association (IrDA) technology, ultra wideband (UWB) technology, Bluetooth (BT) technology and other technologies.

In an example, the terminal device 1300 may be implemented by at least one application-specific integrated circuit (ASIC), digital signal processor (DSP), digital signal processing device (DSPD), programmable logic device (PLD), field-programmable gate array (FPGA), controller, microcontroller, microprocessor, or other electronic elements for executing the methods shown in FIG. 2 to FIG. 5 above.

In an example, a non-temporary computer readable storage medium including instructions, such as the memory 1304 including instructions, which can be executed by the processor 1320 of the terminal device 1300 to complete the above methods shown by FIG. 2 to FIG. 5, is further provided. For example, the non-temporary computer readable storage medium may be a Read-Only Memory (ROM), a random access memory (RAM), a CD-ROM, a magnetic tape, a floppy disk, an optical data storage device, etc.

Other implementation schemes of the disclosure will be apparent to those skilled in the art from consideration of the specification and practice of the disclosure here. The disclosure is intended to cover any variations, uses, or adaptations of the disclosure that follow the general principles of the disclosure and include common knowledge or customary technical means in the art not disclosed in the disclosure.

It is to be understood that the disclosure is not limited to the exact construction that has been described above and illustrated in the accompanying drawings, and that various modifications and changes may be made without departing from its scope.

In order to implement the above example, an example of the disclosure further provides a communication apparatus, which may be a network device or a user equipment, may also be a chip, a chip system, or a processor, etc., that supports the network device to implement the above method, and may also be a chip, a chip system, or a processor, etc., that supports the user device to implement the above method. The apparatus may be configured to implement the method described in any one of the above method examples, which may refer to the description in the above method examples for details.

The communication apparatus may include one or more processors. The processor may be a general purpose processor or a specialized processor, etc. It may be, for example, a baseband processor or a central processing unit. The baseband processor may be configured to process a communication protocol and communication data, and the central processing unit may be configured to control a communication apparatus (e.g., a base station, a baseband chip, a user equipment, a user equipment chip, a DU or a CU, etc.), executing a computer program, and processing data from the computer program.

Alternatively, one or more memories may also be included in the communication apparatus on which a computer program may be stored, and the processor executes the computer program to enable the communication apparatus to execute the methods described in the method examples above. Alternatively, data may also be stored in the memory. The communication apparatus and the memory may be arranged separately or may be integrated together.

Alternatively, the communication apparatus may also include a transceiver, and an antenna. The transceiver may be referred to as a transceiving unit, a transceiver, or a transceiving circuit, etc., and is configured to implement a transceiving function. The transceiver may include a receiver and a transmitter, the receiver may be referred to as a receiving machine or receiving circuit, etc., for implementing a receiving function, and the transmitter may be referred to as a transmitting machine or transmitting circuit, etc., for implementing a transmitting function.

Alternatively, one or more interface circuits may also be included in the communication apparatus. The interface circuit is configured to receive a code instruction and transmitting the code instruction to the processor. The processor runs the code instruction so as to enable the communication apparatus to execute the method described in any one of the method examples above.

In an implementation, the processor may include a transceiver for implementing receiving and transmitting functions. For example, the transceiver may be a transceiving circuit, or an interface, or an interface circuit. The transceiving circuit, interface or interface circuit configured to implement the receiving and transmitting functions may be separate or integrated together. The above transceiving circuit, interface or interface circuit may be configured to read and write of a code/data, or the above transceiving circuit, interface or interface circuit may be configured to transmit or pass of a signal.

In an implementation, the processor may store a computer program, and the computer program run on the processor may enable the communication apparatus to execute the method described in the any one method example above. The computer program may be solidified in the processor, in which case the processor may be implemented by hardware.

In an implementation, the communication apparatus may include a circuit, and the circuit may implement the function of transmitting or receiving or communicating in the foregoing method example. The processor and transceiver described in the disclosure may be implemented on an integrated circuit (IC), an analog IC, a radio frequency integrated circuit (RFIC), a mixed signal IC, an application-specific integrated circuit (ASIC), a printed circuit board (PCB), an electronic device, and the like. The processor and the transceiver may also be fabricated using a variety of IC process technologies, such as a complementary metal oxide semiconductor (CMOS), an nMetal-Oxide-Semiconductor (NMOS), a positive channel metal oxide semiconductor (P-type metal oxide semiconductor, PMOS), a bipolar junction transistor (BJT), a bipolar CMOS (BiCMOS), silicon germanium (SiGe), gallium arsenide (GaAs), and so on.

The communication apparatus in the description of the above example may be a network device or a user device, but the scope of the communication apparatus described in the disclosure is not limited to this. The communication apparatus may be a separate device or may be part of a larger device. For example, the communication apparatus may be:
(1) a separate integrated circuit (IC), or chip, or, a chip system or subsystem;
(2) a set having one or more ICs, alternatively, the set of ICs may also include a storage component for storing data and a computer program;
(3) an ASIC, such as a modem;
(4) a module that may be embedded within other devices;
(5) a receiver, a user equipment, an intelligent terminal device, a cellular phone, a wireless device, a handset, a mobile unit, an in-vehicle device, a network device, a cloud device, an artificial intelligence device, etc. ; and
(6) other, etc.

On a condition that the communication apparatus may be a chip or a chip system, the chip may include a processor and an interface. One or more processors may be arranged, and a plurality of interfaces may be arranged.

Alternatively, the chip further includes a memory, and the memory is configured to store necessary computer programs and data.

Those skilled in the art may further appreciate that various illustrative logical blocks and steps set forth in the examples of the disclosure may be implemented by electronic hardware, computer software, or a combination of the two. Whether such a function is implemented by hardware or software depends on a specific application and design requirements of an overall system. Those skilled in the art may, for each specific application, use various methods to implement the described function, but such implementation is not to be construed as being outside the scope of protection of the examples of the disclosure.

The disclosure further provides a computer program product. When executed by a computer, the computer program product implements the functions of the above examples of FIG. 2 to FIG. 5.

The disclosure further provides a computer program product. When executed by a computer, the computer program product implements the functions of the above examples of FIG. 6 to FIG. 9.

In the above example, the function may be implemented in whole or in part by software, hardware, firmware, or any combination of them. When implemented by software, the function may be implemented in whole or in part in the form of the computer program product. The computer program product includes one or more computer programs. When the computer program is loaded and executed on a computer, the process or function described according to the examples of the disclosure is generated in whole or in part. The computer may be a general-purpose computer, a specialized computer, a computer network, or other programmable apparatuses. The computer program may be stored in a computer readable storage medium or transmitted from one computer readable storage medium to another computer readable storage medium. For example, the computer program may be transmitted from one website, computer, server, or data center to another website, computer, server, or data center by wired (e.g., a coaxial cable, optical fiber, and digital subscriber line (DSL)) or wireless (e.g., infrared, wireless, microwave, etc.) means. The computer readable storage medium may be any available medium to which a computer can access or a data storage device such as a server, data center, etc., that contains one or more available medium integrations. The available medium may be a magnetic medium (e.g., a floppy disk, a hard disk, and a tape), an optical medium (e.g., a high-density digital video disc (DVD)), or a semiconductor medium (e.g., a solid state disk (SSD)), etc.

Those ordinarily skilled in the art may understand that first, second, and various other numerical numbers involved in the disclosure are merely distinguished for descriptive convenience, are not configured to limit the scope of the examples the disclosure.

At least one in the disclosure may also be described as one or more, and a plurality may be two, three, four, or more, without limitation of the disclosure. In the examples of the disclosure, for a technical feature, technical features in the technical feature are distinguished by “first”, “second”, “third”, “A”, “B”, “C”, “D”, etc. There is no order of precedence or magnitude among the technical features described in “first”, “second”, “third”, “A”, “B”, “C” and “D”.

Correspondences shown in tables in the disclosure may be configured or may be predefined. Values of information in the tables are merely examples and may be configured to other values, which is not limited by the disclosure. When a correspondence between information and each parameter is configured, it is not necessarily required that all correspondences illustrated in each table must be configured. For example, the correspondence illustrated in certain rows of the tables in the disclosure may also be unconfigured. For another example, appropriate distortion adjustments may be made on the basis of the above table, e.g., splitting, merging, etc. Names of parameters shown in headings in the above tables may also be other names understandable by the communication apparatus, and values or representations of the parameters of which may also be other values or representations understandable by the communication apparatus. Each of the above tables may also be implemented with other data structures. For example, an array, a queue, a container, a stack, a linear table, a pointer, a chained table, a tree, a graph, a structure, a class, a heap, a hash table, or a hash table, etc. may be used.

Predefining in the disclosure may be understood as defining, defining in advance, storing, pre-storing, pre-negotiating, pre-configuring, curing, or pre-firing.

Those ordinarily skilled in the art may realize that units and algorithmic steps of the various examples described in conjunction with the examples disclosed here can be implemented with electronic hardware, or a combination of computer software and electronic hardware. Whether these functions are performed in a form of hardware or software depends on the specific application and design constraints of the technical solutions. Those skilled in the art may use different methods to implement the described functions for each specific application, but such implementation is not considered to be beyond the scope of the disclosure.

It is clearly understood by those skilled in the art to which it belongs that, for the convenience and brevity of the description, the specific work processes of the systems, apparatuses, and units described above can refer to the corresponding processes in the foregoing method examples, which will not be repeated here.

The above is merely the specific implementations of the disclosure, but the scope of protection of the disclosure is not limited to this. Changes or replacements that can be easily thought of by those skilled in art within the technical scope disclosed in the disclosure are to be covered in the scope of protection of the disclosure.

1. A sidelink communication method, performed by a terminal device, the sidelink communication method comprising:
receiving sidelink transmission resource information from a network device, wherein the sidelink transmission resource information at least comprises sidelink transmission resource information on a shared frequency; and
selecting a sidelink transmission resource for transmitting a sidelink message according to the sidelink transmission resource information.

2. The sidelink communication method according to claim 1, wherein receiving the sidelink transmission resource information from the network device comprises:
determining that the terminal device is in an inactive state or an idle state; and
receiving a system broadcast message from the network device, wherein the sidelink transmission resource information is carried in the system broadcast message; or
determining that the terminal device is in a connected state; and
receiving a Radio Resource Control (RRC) message from the network device, wherein the sidelink transmission resource information is carried in the RRC message.

3. The sidelink communication method according to claim 1, wherein the sidelink transmission resource information is configured to indicate a sidelink transmission resource pool for transmission of the sidelink message; and
the sidelink transmission resource information comprises at least one time-frequency resource location, and the at least one time-frequency resource location is configured to indicate the sidelink transmission resource in the sidelink transmission resource pool.

4. The sidelink communication method according to claim 3, wherein the sidelink communication method further comprises:
receiving at least one piece of first configuration information from the network device, wherein the at least one piece of first configuration information corresponds to at least one piece of the sidelink transmission resource information; and the first configuration information comprises a first indication, configured to indicate whether the sidelink transmission resource is configured to transmit a sidelink discovery message or a sidelink communication message; and
selecting the sidelink transmission resource for transmitting the sidelink message according to the sidelink transmission resource information comprises:
determining that the sidelink message is the sidelink discovery message; and
selecting, from a sidelink transmission resource pool indicated by first sidelink transmission resource information, the sidelink transmission resource for transmitting the sidelink message; wherein a first configuration information corresponding to the first sidelink transmission resource information indicates that the sidelink transmission resource is configured to transmit the sidelink discovery message;
or
determining that the sidelink message is the sidelink communication message; and
selecting, from a sidelink transmission resource pool indicated by second sidelink transmission resource information, the sidelink transmission resource for transmitting the sidelink message; wherein a first configuration information corresponding to the second sidelink transmission resource information indicates that the sidelink transmission resource is configured to transmit the sidelink communication message.

5. The sidelink communication method according to claim 3, further comprising:
receiving at least one piece of second configuration information from the network device, wherein the at least one piece of second configuration information corresponds to at least one piece of the sidelink transmission resource information on the shared frequency; and the second configuration information comprises a use condition, wherein the use condition comprises at least one of the following conditions:
a service attribute condition, configured to indicate that a service attribute of the sidelink message needs to be consistent with a service attribute corresponding to the service attribute condition;
a Reference Signal Received Power (RSRP) threshold value and a corresponding first judgment condition, configured to indicate that a magnitude relationship between an RSRP value of the terminal device and the RSRP threshold value needs to meet the first judgment condition;
a Channel Busy Ratio (CBR) threshold value and a corresponding second judgment condition, configured to indicate that a magnitude relationship between a CBR value measured by the terminal device and the CBR threshold value needs to meet the second judgment condition; wherein the CBR value is measured by the terminal device for the sidelink transmission resource pool indicated by the sidelink transmission resource information; or
a geographic location condition, configured to indicate that a geographic location where the terminal device is located needs to be consistent with a geographic location corresponding to the geographic location condition.

6. The sidelink communication method according to claim 5, wherein selecting the sidelink transmission resource for transmitting the sidelink message according to the sidelink transmission resource information comprises:
determining that the at least one piece of second configuration information comprises the use condition and the use condition is met; and
selecting, from the sidelink transmission resource pool indicated by a sidelink transmission resource message on the shared frequency corresponding to the second configuration information whose comprised use condition is met, the sidelink transmission resource for transmitting the sidelink message;
or
determining that the at least one piece of second configuration information comprises the use condition, and the comprised use condition is not met; and
selecting, from a sidelink transmission resource pool indicated by sidelink transmission resource information on an unshared frequency, the sidelink transmission resource for transmitting the sidelink message.

7. The sidelink communication method according to claim 5, wherein the first judgment condition comprises that the RSRP value of the terminal device is greater than or equal to the RSRP threshold value, or the RSRP value of the terminal device is less than the RSRP threshold value; and
the second judgment condition comprises that the CBR value of the terminal device is greater than or equal to the CBR threshold value, or the CBR value of the terminal device is less than the CBR threshold value;
wherein the CBR value is measured for the sidelink transmission resource pool indicated by the sidelink transmission resource information on the shared frequency; or the CBR value is measured for the sidelink transmission resource pool indicated by sidelink transmission resource information on an unshared frequency.

8. The sidelink communication method according to claim 1, wherein the terminal device is in a connected state, and before receiving the sidelink transmission resource information on the shared frequency from the network device, the sidelink communication method further comprises:
reporting a capability indication to the network device, wherein the capability indication is configured to indicate whether the terminal device supports transmission of the sidelink message by adopting a sidelink transmission resource on the shared frequency;
wherein the sidelink transmission resource information on the shared frequency is transmitted to the terminal device on a condition that the network device determines that the terminal device supports the transmission of the sidelink message by adopting the sidelink transmission resource on the shared frequency.

9. The sidelink communication method according to claim 1, further comprising:
receiving third configuration information from the network device;
wherein the third configuration information is configured to indicate whether a sidelink message from a sidelink logical channel or a bearer can be transmitted on a sidelink transmission resource on the shared frequency;
or
the third configuration information is configured to indicate whether a sidelink message to be transmitted to a destination terminal device can be transmitted on the sidelink transmission resource on the shared frequency.

10. The sidelink communication method according to claim 9, wherein selecting the sidelink transmission resource for transmitting the sidelink message according to the sidelink transmission resource information comprises:
determining that the sidelink message comes from a first sidelink logical channel or the bearer; and
selecting, from a sidelink transmission resource pool indicated by the sidelink transmission resource information on the shared frequency, the sidelink transmission resource for transmitting the sidelink message;
wherein the third configuration information indicates that the sidelink message from the first sidelink logical channel or the bearer can be transmitted on the sidelink transmission resource on the shared frequency;
or
determining that the destination terminal device for the sidelink message is a first destination terminal device; and
selecting, from a sidelink transmission resource pool indicated by the sidelink transmission resource information on the shared frequency, the sidelink transmission resource for transmitting the sidelink message;
wherein the third configuration information indicates that the sidelink message to be transmitted to the first destination terminal device can be transmitted on the sidelink transmission resource on the shared frequency;
or
determining that the terminal device receives a transmission resource on the shared frequency scheduled by the network device, and that the sidelink message comes from the first sidelink logical channel or the bearer; and
transmitting the sidelink message by the transmission resource on the shared frequency scheduled by the network device;
wherein the third configuration information indicates that the sidelink message from the first sidelink logical channel or the bearer can be transmitted on the sidelink transmission resource on the shared frequency:
or
determining that the terminal device receives a transmission resource on the shared frequency scheduled by the network device, and that the destination terminal device for the sidelink message is a first destination terminal device; and
transmitting the sidelink message by the transmission resource on the shared frequency scheduled by the network device;
wherein the third configuration information indicates that the sidelink message to be transmitted to the first destination terminal device can be transmitted on the sidelink transmission resource on the shared frequency.

11. (canceled)

12. (canceled)

13. (canceled)

14. A sidelink communication method, performed by a network device, the sidelink communication method comprising:
transmitting sidelink transmission resource information to a terminal device, wherein the sidelink transmission resource information at least comprises sidelink transmission resource information on a shared frequency.

15. The sidelink communication method according to claim 14, wherein transmitting the sidelink transmission resource information to the terminal device comprises:
transmitting a system broadcast message to the terminal device in an inactive state or an idle state, wherein the sidelink transmission resource information is carried in the system broadcast message;
or
transmitting a Radio Resource Control (RRC) message to the terminal device in a connected state, wherein the sidelink transmission resource information is carried in the RRC message.

16. The sidelink communication method according to claim 14, wherein the sidelink transmission resource information is configured to indicate a sidelink transmission resource pool for transmission of a sidelink message; and
the sidelink transmission resource information comprises at least one time-frequency resource location, and the at least one time-frequency resource location is configured to indicate the sidelink transmission resource in the sidelink transmission resource pool.

17. The sidelink communication method according to claim 16, further comprising:
transmitting at least one piece of first configuration information to the terminal device, wherein the at least one piece of first configuration information corresponds to at least one piece of the sidelink transmission resource information; and the first configuration information comprises a first indication, configured toused indicate whether the sidelink transmission resource is configured to transmit a sidelink discovery message or a sidelink communication message.

18. The sidelink communication method according to claim 16, further comprising:
transmitting at least one piece of second configuration information to the terminal device, wherein the at least one piece of second configuration information corresponds to at least one piece of the sidelink transmission resource information on the shared frequency; and the second configuration information comprises a use condition, wherein the use condition comprises at least one of the following conditions:
a service attribute condition, configured toused indicate that a service attribute of the sidelink message needs to be consistent with a service attribute corresponding to the service attribute condition;
a Reference Signal Received Power (RSRP) threshold value and a corresponding first judgment condition, configured to indicate that a magnitude relationship between an RSRP value of the terminal device and the RSRP threshold value needs to meet the first judgment condition;
a Channel Busy Ratio (CBR) threshold value and a corresponding second judgment condition, configured to indicate that a magnitude relationship between a CBR value measured by the terminal device and the CBR threshold value needs to meet the second judgment condition; wherein the CBR value is measured by the terminal device for the sidelink transmission resource pool indicated by the sidelink transmission resource information; or
a geographic location condition, configured to indicate that a geographic location where the terminal device is located needs to be consistent with a geographic location corresponding to the geographic location condition.

19. The sidelink communication method according to claim 18, wherein the first judgment condition comprises that the RSRP value of the terminal device is greater than or equal to the RSRP threshold value, or the RSRP value of the terminal device is less than the RSRP threshold value; and
the second judgment condition comprises that the CBR value of the terminal device is greater than or equal to the CBR threshold value, or the CBR value of the terminal device is less than the CBR threshold value;
wherein the CBR value is measured for the sidelink transmission resource pool indicated by the sidelink transmission resource information on the shared frequency; or the CBR value is measured for the sidelink transmission resource pool indicated by sidelink transmission resource information on an unshared frequency.

20. The sidelink communication method according to claim 14, before transmitting the sidelink transmission resource information on the shared frequency to the terminal device in a connected state, further comprising:
receiving a capability indication reported by the terminal device, wherein the capability indication is configured to indicate whether the terminal device supports transmission of a sidelink message by adopting a sidelink transmission resource on the shared frequency;
wherein the sidelink transmission resource information on the shared frequency is transmitted to the terminal device on a condition that the network device determines that the terminal device supports the transmission of the sidelink message by adopting the sidelink transmission resource on the shared frequency.

21. The sidelink communication method according to claim 14, further comprising:
transmitting third configuration information to the terminal device;
wherein the third configuration information is configured to indicate whether a sidelink message from a sidelink logical channel or a bearer can be transmitted on a sidelink transmission resource on the shared frequency;
or
the third configuration information is configured to indicate whether a sidelink message to be transmitted to a destination terminal device can be transmitted on the sidelink transmission resource on the shared frequency.

22. (canceled)

23. (canceled)

24. A sidelink communication apparatus, comprising one or more processors and a memory, wherein
the one or more processors are collectively configured to:
receive sidelink transmission resource information from a network device, wherein the sidelink transmission resource information at least comprises sidelink transmission resource information on a shared frequency; and
select a sidelink transmission resource for transmitting a sidelink message according to the sidelink transmission resource information.

25. A sidelink communication apparatus, comprising a processor and a memory, wherein a computer program is stored in the memory, and the computer program stored in the memory can be executed by the processor to enable the sidelink communication apparatus to execute the sidelink communication method according to claim 14.

26-29. (canceled)
